(19) United States
(12) Patent Application Publication
(10) Pub. No.: US 2013/0301043 A1
(43) Pub. Date: Nov. 14, 2013

(54) ILLUMINATION CHAMBER FOR RAMAN SPECTROSCOPY

(71) Applicants: Philippe Bourget, Saint Mande (FR); Bruno Cassard, Fontenay sour Bois (FR)

(72) Inventors: Philippe Bourget, Saint Mande (FR); Bruno Cassard, Fontenay sour Bois (FR)

(73) Assignee: Assistance Publique-Hopitaux de, Paris (FR)

(21) Appl. No.: 13/877,984

(22) PCT Filed: Oct. 7, 2011
(86) PCT No.: PCT/EP11/67533

§ 371 Date: Jul. 10, 2013

(30) Foreign Application Priority Data
Oct. 7, 2010 (FR) 10581167

(51) Int. Cl. G01N 21/01; G01N 21/65

(52) U.S. Cl. CPC G01N 21/01; G01N 21/65
USPC 356/301

(57) ABSTRACT

The invention relates to a chamber for analyzing a sample by means of Raman spectroscopy, characterized in that the chamber is provided in the form of an opaque parallelepiped having: (a) on one of the vertical walls thereof, a hatch for introducing a sample; (b) on the bottom wall thereof, a first opening, and means (4) for attaching a light source, for providing excitation radiation, and a lens (22) enabling the convergence of the excitation radiation so as to define a focal point for the excitation radiation; and (c) a second opening and means for attaching a sensor enabling the Raman scattered light to be detected on a vertical wall or the bottom wall, said attachment means (4) including adjustment means (8) for varying said focal point of the excitation radiation along a vertical axis, so as to enable an adjustment of the height of said focal point within the analysis chamber.

The invention relates to the field of monitoring the nature of samples by Raman spectroscopy. In particular, the invention can be particularly used for the analytical quality control (AQC) of products prepared extemporaneously in hospital pharmacies.

The “certification of therapeutic objects (OT)” via the legal in situ AQC concept, aims in fact to guarantee the parameters, identity, purity and concentration of the molecules of interest. These products can be of high added value (for example monoclonal antibodies), or require precautions for use (for example a cytotoxity for products intended for chemotherapies).

In the best case, this analysis should be fast (result in a few minutes and before perfusion to the patient), have no effect on the sample, and not require the sample to be sampled for control purposes (some samples cannot be sampled without being destroyed).

With this in mind, Raman spectroscopy offers a certain number of advantages:
respect for the integrity of the therapeutic object: no drawing-off or destruction of the sample
direct/extemporaneous analysis, even through the walls of the therapeutic object
analyses conducted in ambient conditions
spectral signatures of the containers, vehicles, molecules of interest obtained simultaneously
extremely fast (<2 min)/functional flexibility compatible with the legal AQC principles, i.e. immediately before administration of the OT to the patient. This speed of response also makes it possible to re-prepare an OT declared “non-conforming”
no use of consumables or generation of production waste: environmental protection and sustainable development
remarkable specificity (demands analytical appraisal)
relatively simple to implement, compared to the reference separative methods
relatively low financial investment (some tens of thousands of euros)
low maintenance cost: few moving parts, motors, etc.
equipment size rendering it useable in CPCI (unit for hospital or non-hospital production of injectables or chemotherapies)
potentially huge scope for application
water scatters almost not at all in Raman spectroscopy, making it useful as “reference spectrum”.

The use of Raman technology also makes it possible to identify, and still non-intrusively, the vehicle (NaCl 0.9%, G5%, water ppi etc.) conveying the molecule of interest.

The principle of Raman spectroscopy is as follows: the radiations of a powerful monochromatic source (laser) are conducted in an optical fiber, and focused on the sample to be analyzed, thus provoking its excitation. The light scattered by the sample is collected by a sensor, then routed by an optical fiber to the separator (monochromator). Coupled to a detector, the latter then supplies data concerning the sample which has then only to be processed by computer. Generally, the light scattered either at 180° or at 90° is collected.

By comparison with reference spectra, it thus becomes possible to characterize the nature of the product present in the sample, its concentration, as well as the presence of any impurities.

It is a local measurement technique: the laser beam is focused on a small part of the sample, and makes it possible to study the properties of this sample on a volume of a few cubic microns.

This technology has already been used to analyze gelatine capsules, or injectable solutions, and, in particular, directly in plastic bottles.

The particular issue that arises in the hospital environment for the implementation of AQC is the diversity of the therapeutic objects to be studied, both in their composition and in the nature and the form of the container. In practice, these therapeutic objects, when injectable solutions are involved, can be present in syringes (of varying volumes), perfusion bags, bottles, beakers or similar vessels, ampoules or portable infusers.

Portable infusers are light and disposable devices for allowing a slow and continuous perfusion of chemotherapy. The chemotherapy product is contained in a flexible balloon tank, which is itself placed inside a rigid container.

The wide variety of the therapeutic objects and of their geometry demands the availability of a system that makes it possible to apply the Raman spectroscopy method to these objects, easily. Moreover, since hospital pharmacies prepare many therapeutic objects, it is necessary to be able to replace one object with another rapidly, without the parameterizing of the excitation light source being difficult to perform. Finally, the operators should also be protected from any exposure to the laser beam or the scattered light.

The invention thus relates to a chamber for analyzing a sample by Raman spectroscopy, characterized in that it in the form of an opaque parallelepiped, having
(a) a hatch for introducing a sample, on one of its vertical walls,
(b) a first orifice and means (4) for fastening a light source to supply an excitation radiation and a lens allowing for the convergence of the excitation radiation in order to define a focal point of the excitation radiation, on the bottom wall,
(c) a second orifice and means for fastening a sensor making it possible to detect the Raman scattered light, on a vertical wall or on the bottom wall,
   said fastening means (4) comprising adjustment means (8) making it possible to vary said focal point of the excitation radiation on a vertical axis, in order to allow for an adjustment of the height of said focal point within the analysis chamber.

The terms “vertical”, “bottom” are linked to the way in which the chamber is preferentially put in place during its use for analyzing a sample. De facto, this clearly means that the hatch for introducing a sample is located on a first wall. The first orifice and the means (4) for fastening a light source to supply an excitation radiation and a lens (22) allowing for the convergence of the excitation radiation in order to define a focal point of the excitation radiation are located on a second wall which is therefore at right angles (perpendicular) to the first wall.

The second orifice and the fastening means of a sensor making it possible to detect the Raman scattered light are located on a wall which is not parallel to (facing) the second wall.

In this embodiment, the light source (laser head) and the lens are located on the bottom wall of the chamber according to the invention. The light is thus sent from bottom to top. This embodiment is preferred because it makes it possible to characterize the sample placed on the base plate of the bottom wall, above the first orifice.

However, in other embodiments which also form part of the invention, it is possible to locate the head of the laser on a flank (the first orifice then being in a side wall of the chamber), this amounting in fact to “turning” the chamber during its use. It is also possible to locate several laser heads, for the acquisition of Raman data in different points of the sample. In this case, it should however be checked that there is no interference between the different detectors, in order for each of them to detect the light scattered after excitation by a specific head.

As has been seen, Raman spectroscopy amounts to collecting and analyzing the light scattered by the sample after excitation, generally at 90° or 180° from the axis of the excitation laser beam.

In a preferred embodiment, the second orifice is combined with the first orifice. In this embodiment, the scattered light is collected at 180°. In this embodiment, the fastening means (4) and the fastening means of said sensor are also combined. They then contain two optical fibers (one bringing the light permitted via the laser head, and the second conveying the light scattered by the sample to the monochromotor and the detector).

Because of the great variability of the therapeutic objects to be tested, and in particular the thickness of the containers, it should be possible to move the focal point of the excitation light, in order for it to be located in the sample, at approximately 1 cm above the container of the therapeutic object. This distance in particular makes it possible to avoid the “edge effects” linked to the container.

As mentioned above, the laser (parallel monochromatic light source) is coupled to a lens allowing for the convergence of the light beams in a small volume of the sample that is to be analyzed. The distance between the lens and the point of convergence is known to the operator and is expressed by the focal length of the lens.

In one embodiment, the fastening means (4) make it possible to move, together, both the light source (the laser head) and the lens.

In another embodiment, the laser head is fixed relative to the bottom wall of the analysis chamber, and only the lens can move on the vertical axis.

In a preferred embodiment, said fastening means (4) of said light source and of the lens comprise a light-tight sleeve, fastened to the bottom wall of the chamber.

In a particular embodiment, this sleeve is screwed to the bottom wall of the illumination chamber. In this embodiment, recesses can be machined in the base plate, to introduce the screws, in order to maintain the flatness of the base plate after fastening the sleeve.

The light-tightness of the sleeve is obtained by producing the latter in an opaque material (such as polycarbonate). This makes it possible to both avoid the “contamination” of the light beam by the ambient light and protect the operators.

In a particular embodiment, the adjustment means of the moving assembly (which is the light source and the lens when these two elements are attached together or the lens alone) comprise a millimetric screw. The use of a millimetric screw thus makes it possible to move on the elements that have to be able to move on the vertical axis very accurately. It is thus possible to use a millimetric screw allowing for positioning to within a hundredth of a millimeter. The principle of the millimetric screw is to induce a translational movement from a rotational movement of the screw. The screw pitch makes it possible to define the accuracy of the screw (translational movement for each turn of the screw).

In a preferred embodiment, this screw is linked to a counter making it possible to know the movement of the screw, equal to that of the moving assembly, and therefore the height of the focal point within the chamber according to the invention.

By way of illustration, it is assumed that the focal length of the lens is 20 mm, and that the moving assembly is flush with the base plate of the chamber at the point 0 of the counter. This means that the focal point of the light is located 20 mm above the base plate.

If the aim were to analyze a sample present in a plastic container 1 mm thick, it would therefore be necessary to obtain the focus at 11 mm above the base plate (approximately 1 cm into the sample), which would therefore mean lowering the mobile object by 9 mm.

If the sample is present in a syringe having a thickness of 3 mm, the moving object is lowered by 7 mm.

The person skilled in the art thus determines the adjustment to be made to the moving object as a function of the focal length of the lens, and of the nature of the therapeutic object, and in particular the thickness of the container.

The chamber according to the invention (Raman illumination chamber) may be fastened on a frame comprising feet.

This frame may also comprise means making it possible to adjust the height of the chamber relative to the frame (for example adjustable feed on screw jack). In this case, it may be advantageous for the chamber to include flatness measuring means, such as a spirit level, in order to check that the base plate is perfectly horizontal.

The walls of the chamber are machined from any opaque material. It should be noted that the different walls may be made of different materials. In a preferred embodiment, a material is used, at least for the base plate, that makes it possible to guarantee the best possible flatness, by avoiding relief irregularities on the base plate to the greatest possible extent. It is thus possible to use polycarbonate or carbon material. The thickness of the walls of the chamber according to the invention is defined by the person skilled in the art, is generally greater than 0.5 cm and generally does not exceed a few centimeters. It is thus possible to use walls of carbon 1 cm thick.

The opacity of the chamber makes it possible to avoid measurement interference that might be due to the ambient light when implementing the Raman spectroscopy measurement. It also makes it possible to protect the operators.

The hatch for introducing the sample into the chamber according to the invention can be of any kind. It is, however, important for it to preserve the opacity of the chamber once closed. A seal can therefore be provided for this purpose.

The hatch may thus slide guillotine-fashion along a side wall (from top to bottom or from bottom to top). It may also be open via a system of hinges, or a rack (motorized or not). It is also possible to envisage return systems (such as springs) making it possible to assist the operator in closing this hatch after the sample has been put in place. It may be fastened in the closed position by any means (magnet, hook etc.).

The invention also relates to a method for analyzing a sample present in a container comprising the steps of
(a) placing said sample on the base plate of the chamber according to the invention, vertical to said first orifice and facing said second orifice,
(b) actuating the adjustment means (8) in order to position the focal point of the excitation radiation in the sample at approximately 1 cm above said container,
(c) emitting said excitation radiation and detecting the Raman scattered light.

Obviously, the excitation radiation is emitted via a light source fixed to the fastening means (4).

The detection of the Raman scattered light is obviously performed via a sensor fixed to the fastening means of a sensor of said chamber.

As has been seen, this method is particularly useful when said sample is a liquid solution, and said container is chosen from a syringe, a perfusion bag, a bottle, a beaker or similar vessel, an ampoule, a portable infuser.

In another embodiment, the method is implemented with a sample which is solid, said container being chosen from a gelatin capsule, a capsule, a solid cladding.

It is, however, also possible to implement this method on solid samples with no container, and in particular tablets. This embodiment also falls within the framework of the invention.

In one embodiment, the excitation radiation is emitted for a duration of between 1 second and one minute.

The excitation duration is defined by the operator and depends in particular on the power of the laser, and on the nature of the sample to be analyzed.

In order to increase the analysis quality, the sample is often subjected to a number of excitation radiations, and the average of the data collected for each excitation is taken.

It should be noted that the present invention also covers the use of Raman spectroscopy, in general, for characterizing the content of a portable infuser.

The invention also covers the use of Raman spectroscopy, in general, for characterizing a cancer treatment, as described in the examples.

### DESCRIPTION OF THE DRAWINGS

FIG. 1 represents a cross-sectional view of an embodiment of fastening and adjustment means according to the invention. The fastening means of the light source (4) can be seen, in the form of a sleeve, as well as the adjustment means (8) in the form of a millimetric screw. A hole (14) allowing for the fastening with a screw can also be seen.

FIG. 2 represents a plan view of the means illustrated in FIG. 1. The three screw holes (14) can be clearly seen as can the location of the lens (22). The light source is located behind the lens (22). The sensor may also be located in the same place as the lens (22).

FIG. 3 shows a general view of fastening (4) and adjustment (8) means applicable according to the invention. The millimetric screw (8) (thumb wheel and screw pitch) can be seen, as can a sleeve (4) containing the laser head, the lens (22) and possibly the sensor. The jacket of the optical fiber (15) allowing for the arrival of the light in the laser head from the energy source is also represented. It may also contain a second optical fiber for transferring the scattered light received by the sensor to the monochromator and to the detector.

FIG. 4 represents a chamber according to the invention. The fastening (4) and adjustment (8) means, fixed to the bottom wall of the chamber, are represented, as is the jacket of the optical fiber (15).

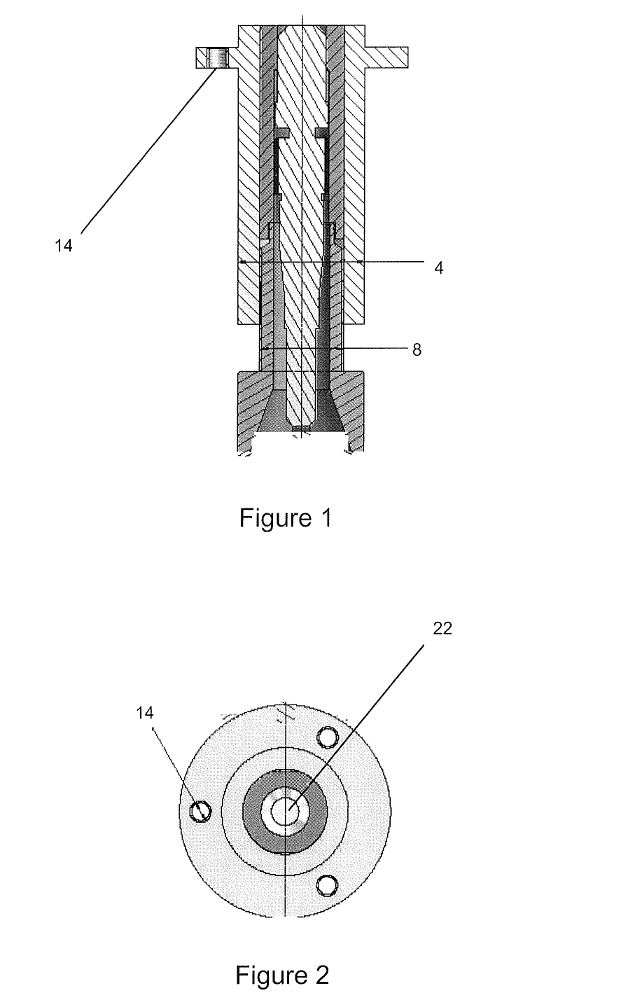

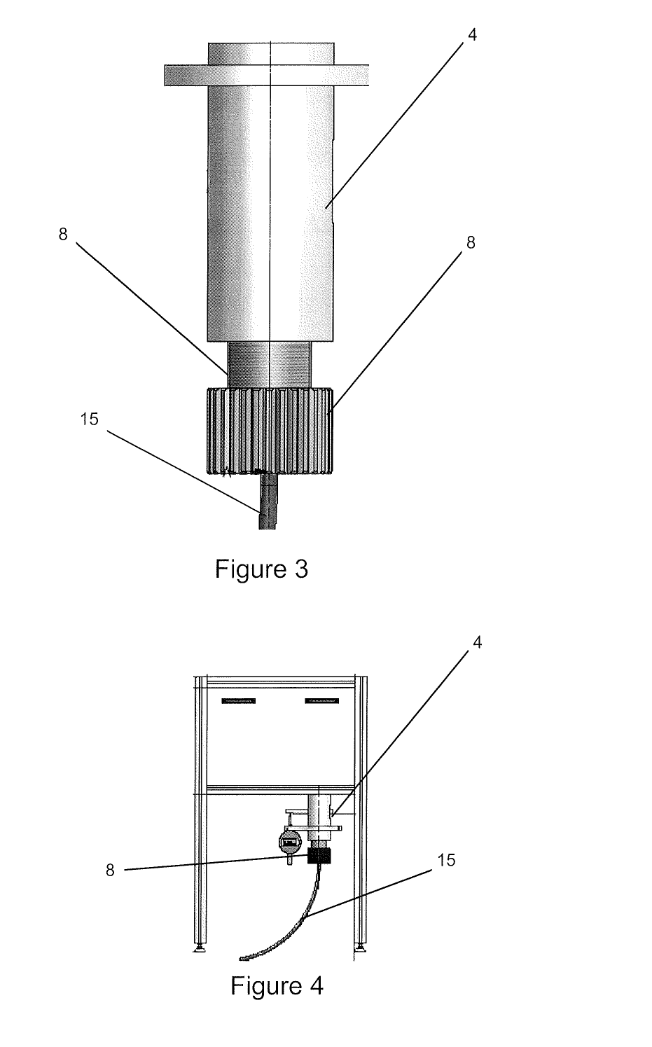

### EXAMPLES

### Example 1

### Application to Oxazaphosphorines (Ifosfamide)

### Procedure

Hardware: Kaiser Optical® RXN1 785 nm Raman spectrometer
   Laser: 785 nm-power 450 mW
Acquisition period: 1 min (chamber)
   5 range points (0-1-5-10-15-20 mg/mL) (3x)
   3 CQs (2-8-16 mg/mL) (6x)
   3 bags for perfusion (2-4-6 mg/mL) (3×)
   Two dilution solvents: NaCl 0.9% and G 5% Validation over 3 days
HPLC protocol: identical (same samples)

### Results

A range of intensity of linear peaks is obtained as a function of the concentration (1 to 20 mg/mL); r²>0.99 (n=9); significant slope (P<0.001−Test F)

The variation of the slopes of the reference ranges<5% and a same-day and between-day reproducibility of the data is observed.

These results show that this technology is applicable to oxazaphosphorines.

### Example II

### Application to Anthracyclines (Ifosfamide)

The same hardware is used as in example 1.

Application of Raman spectroscopy (SR) to AQC for syringes of doxorubicin and epirubicin, in an NaCl 0.9% or glucose 5% vehicle.

These molecules exhibit epimerization: inversion of steric configuration of the fourth carbon of the glucidic fraction and of the UV spectra: identical (λmax 254 nm).

The results obtained show that the Raman spectroscopy makes it possible to measure the concentration of the two products in solution, regardless of the vehicle used, with a good linearity.

Moreover, two characteristic wavelengths (465 cm⁻¹ and 350 cm⁻¹) can be observed for the doxorubicin, making it possible to differentiate it from epirubicin.

The nature of the spectra observed also makes it possible to differentiate the vehicle used.

### Example III

### Application to Portable Infusers

The same hardware is used as in example 1.

The problem with portable infusers is that it is impossible to sample the sample once introduced in the infuser without destroying the infuser. Moreover, the presence of two containers surrounding the sample reduces the strength of the excitation signal (each container absorbing a portion of the excitation energy).

It was possible to show that, despite the presence of the two containers, the Raman spectrometry makes it possible to qualify the nature of the product contained in the portable infusers.

1-10. (canceled)

11. A chamber for analyzing a sample by Raman spectroscopy, characterized in that it takes the form of an opaque parallelepiped, having, during its use for analyzing a sample,
(a) on one of its vertical walls, a hatch for introducing said sample,
(b) on the bottom wall, a first orifice and means (4) for fastening a light source to supply an excitation radiation and a lens (22) allowing for the convergence of the excitation radiation in order to define a focal point of the excitation radiation,
(c) a second orifice and means for fastening a sensor making it possible to detect the Raman scattered light, on a vertical wall or on the bottom wall,
said fastening means (4) comprising adjustment means (8) making it possible to vary said focal point of the excitation radiation on a vertical axis, in order to allow for an adjustment of the height of said focal point within the analysis chamber.

12. The analysis chamber as claimed in claim 11, characterized in that the second orifice is combined with the first orifice.

13. The analysis chamber as claimed in claim 11, characterized in that said fastening means (4) make it possible to move, together, both said light source and said lens (22) allowing for the convergence of the excitation radiation at the focal point.

14. The analysis chamber as claimed in claim 11, characterized in that said fastening means (4) make it possible to move said lens (22) allowing for the convergence of the excitation radiation at the focal point, said light source being fixed relative to the bottom wall of the analysis chamber.

15. The analysis chamber as claimed in claim 11, characterized in that said fastening means (4) of said light source and of said lens (22) comprise a light-tight sleeve, fastened to the bottom wall of the chamber.

16. The analysis chamber as claimed in claim 11, characterized in that said adjustment means (8) allowing for the variation of the focal point of the excitation radiation comprise a millimetric screw.

17. A method for analyzing a sample present in a container comprising the steps of
(a) placing said sample on the base plate of the chamber as claimed in claim 11, vertical to said first orifice and facing said second orifice,
(b) actuating the adjustment means (8) in order to position the focal point of the excitation radiation emitted via a light source fixed to the fastening means (4) in the sample at approximately 1 cm above said container,
(c) emitting said excitation radiation and detecting the Raman scattered light, via a sensor fixed to the fastening means of a sensor of said chamber.

18. The method as claimed in claim 17, characterized in that said sample is a liquid solution, and that said container is chosen from a syringe, a perfusion bag, a bottle, a beaker or similar vessel, an ampoule, a portable infuser (comprising a first sealed external container containing a second flexible internal container containing said sample).

19. The method as claimed in claim 17, characterized in that said sample is solid and that said container is chosen from a gelatin capsule, a capsule, a solid cladding.

20. The method as claimed in claim 18, characterized in that said excitation radiation is emitted for a duration of between one second and one minute.
